(19) United States
(12) Patent Application Publication
(10) Pub. No.: US 2013/0330066 A1
(43) Pub. Date: Dec. 12, 2013

(54) ELECTRONIC DEVICE WITH CAMERA MODULE AND REMOTE SIGNAL RECEIVER

(71) Applicant: FU-FA LE, Shenzhen City (CN)

(72) Inventor: FU-FA LE, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/615,658

(22) Filed: Sep. 14, 2012

(30) Foreign Application Priority Data
Jun. 8, 2012 (CN) 201210187952.X

(51) Int. Cl. G03B 17/00

(52) U.S. Cl. 396/56

(57) ABSTRACT

An electronic device includes a housing. The housing includes a window and defines an inner space. A light guiding element is attached on the front panel and received in the inner space. The light guiding element includes a front portion engaged in the window and a rear portion, and a through hole is extending from the front portion to the rear portion. A camera module is received in the inner space and includes a camera body and a light pervious cover plate. The camera body includes a lens module inserted in the through hole, and the light pervious cover plate is fixed in the window. A printed circuit board is received in the inner space. At least one remote signal receiver is mounted on the printed circuit board, faces the rear portion, and configured for receiving remote signal directed by the light guiding element.

### BACKGROUND

1. Technical Field

The present disclosure relates to electronic devices, and particularly, to an electronic device having an image capturing function and a remote signal receiving function.

2.Description of Related Art

Many electronic devices, such as set-top boxes, include a camera module and a remote signal receiver. The electronic device defines a window in its cover corresponding to the camera module which is configured to admit light. The electronic device also defines another window in its cover corresponding to the remote signal receiver and is configured to admit infrared signals. Such windows may be considered unsightly and their inclusion increases the cost of manufacturing the electronic device.

Therefore, what is needed is a means to solve the problems described above.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the views.

FIG. 1 is an isometric view of an electronic device in accordance with an exemplary embodiment.

FIG. 2 is a disassembled isometric view of the electronic device of FIG. 1.

FIG. 3 is similar to FIG. 2, but showing the electronic device in another perspective.

FIG. 4 is a partially cross-sectional view taken along line IV-IV of FIG. 1.

### DETAILED DESCRIPTION

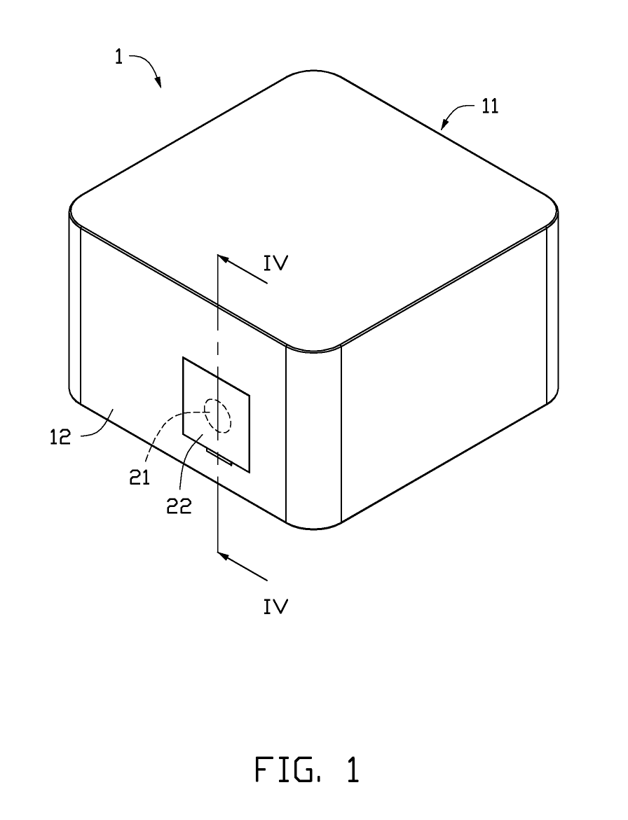

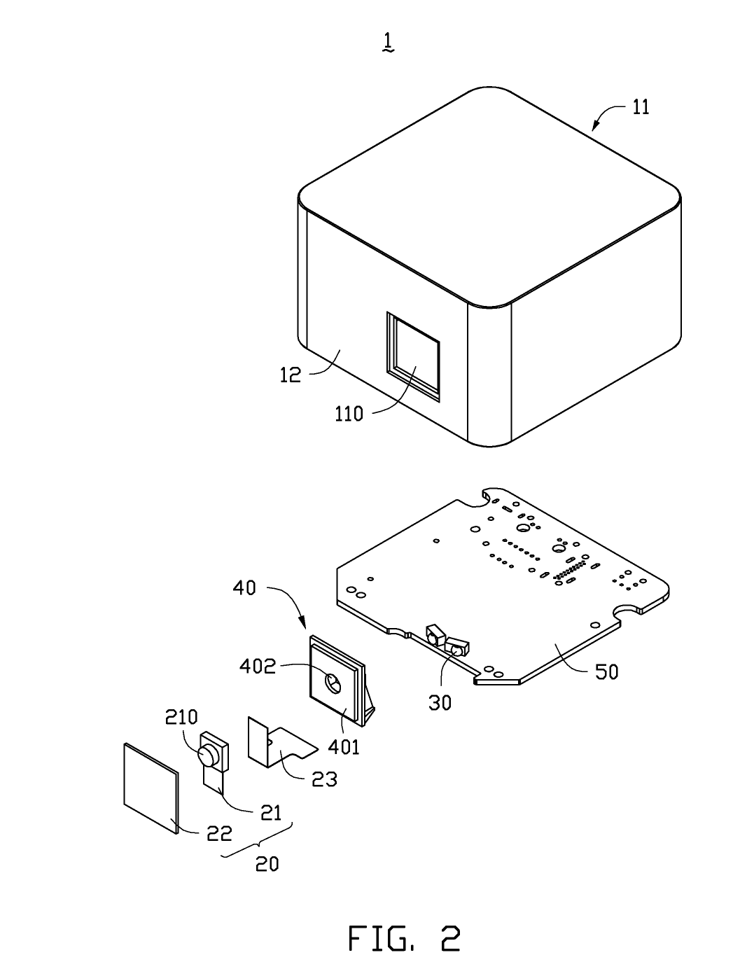

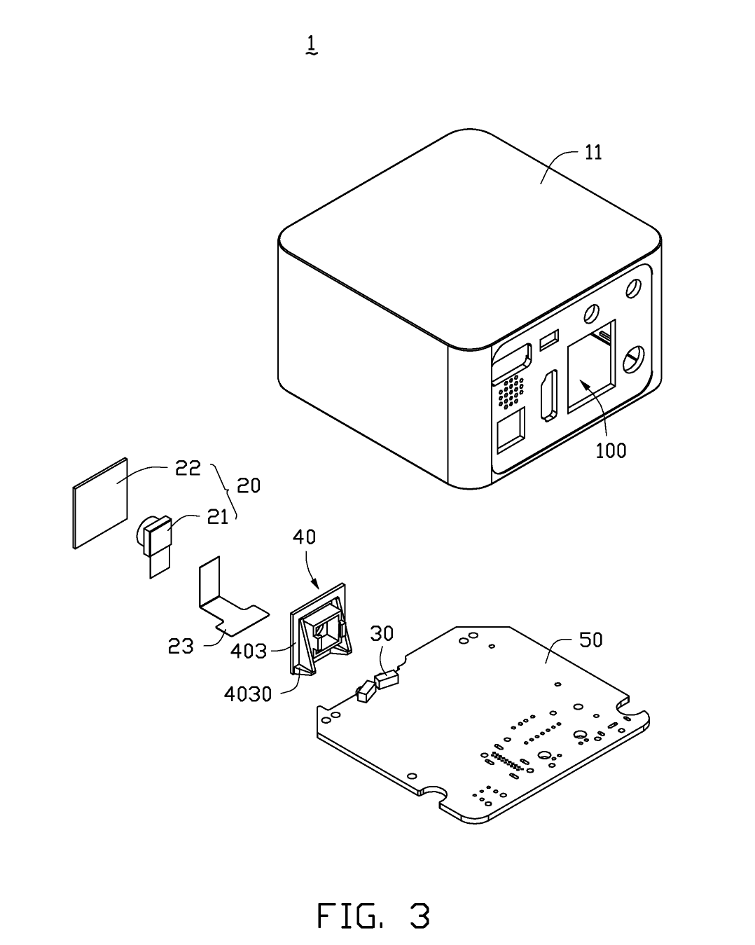

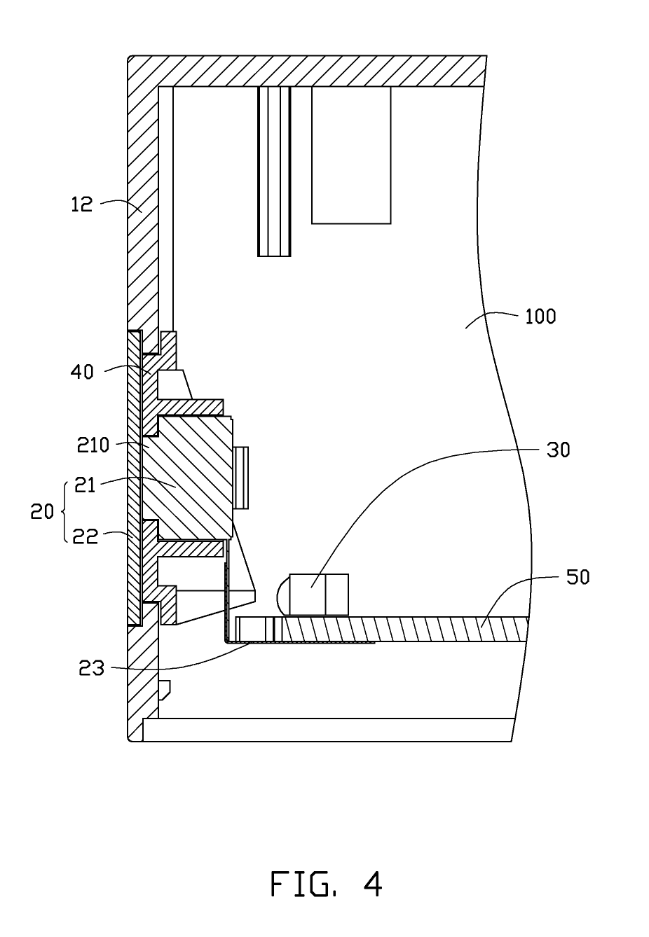

FIGS. 1-4 illustrate an electronic device 1 in accordance with an exemplary embodiment. The electronic device 1 includes a housing 11. An inner space 100 is formed in the housing 11 for receiving a camera module 20 and at least one remote signal receiver 30 such as an infrared sensor.

The housing 11 includes a front panel 12, and the front panel 12 defines a window 110. A light guiding element 40 is received in the inner space 100 and attached on the front panel 12. The light guiding element 40 includes a front portion 401 engaged in the window 110 and a rear portion 403 opposite to the front portion 401. A through hole 402 is extending from the front portion 401 to the rear portion 403. The light guiding element 40 is configured for receiving remote signal at the front portion 401, and further reflecting and directing the remote signal to the remote signal receiver 30. The camera module 20 includes a camera body 21 and a light pervious cover plate 22. The camera body 21 includes a lens module 210 inserted in the through hole 402. The light pervious cover plate 22 is fixed in the window 110 and faces the camera body 21.

In one embodiment, the light pervious cover plate 22 is made of glass, and fixed in the window 110 by means such as gluing or press fit for example. Thus, light from outside the electronic device 1 can pass through the light pervious cover plate 22 into the camera body 21 of the camera module 20, thereby allowing the camera module 20 to capture images.

The remote signal receiver 30 is mounted on a printed circuit board 50 and faces the rear portion 403 of the light guiding element 40, such that the remote signal directed by the light guiding element 40 can be received by the remote signal receiver 30. In one embodiment, the light guiding element 40 is made of transparent material, such as polymethylmethacrylate (PMMA). In one embodiment, the electronic device 1 includes two remote signal receivers 30. The rear portion 403 includes two concave regions 4030. The remote signal receiver 30 are distinctly oriented to respectively face the concave regions 4030, such that the remote signal is directed through the concave regions 4030 to the remote signal receivers 30. Furthermore, the camera module 20 includes a flexible printed circuit board 23 electrically connected to the printed circuit board 50.

It is to be understood, even though information and advantages of the present embodiments have been set forth in the foregoing description, together with details of the structures and functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. An electronic device comprising:
a housing comprising a front panel which defines a window, the housing defining an inner space;
a light guiding element attached on the front panel and received in the inner space, the light guiding element comprising a front portion engaged in the window and a rear portion opposite to the front portion, and a through hole extending from the front portion to the rear portion;
a camera module received in the inner space and comprising a camera body and a light pervious cover plate, the camera body comprising a lens module inserted in the through hole, and the light pervious cover plate being fixed in the window;
a printed circuit board received in the inner space; and
at least one remote signal receiver mounted on the printed circuit board, the light guiding element configured for receiving remote signal at the front portion and directing the remote signal to the remote signal receiver, the at least one remote signal receiver facing the rear portion of the light guiding element and configured for receiving the remote signal directed by the light guiding element.

2. The electronic device of claim 1, wherein the remote signal receiver is an infrared sensor.

3. The electronic device of claim 1, wherein the camera module comprises a flexible printed circuit board electrically connected to the printed circuit board.

4. The electronic device of claim 1, wherein the at least one remote signal receiver comprises two remote signal receivers; the rear portion comprises two concave regions; and the remote signal receivers are distinctly oriented to respectively face the concave regions.
